(19) United States
(12) Patent Application Publication
(10) Pub. No.: US 2009/0122223 A1
(43) Pub. Date: May 14, 2009

(54) LIQUID CRYSTAL DISPLAY PANEL

(75) Inventors: Takayuki Hayano, Mie (JP); Dai Chiba, Mie (JP); Masayuki Tsuji, Mie (JP)

Correspondence Address: SHARP KABUSHIKI KAISHA;C/O KEATING & BENNETT, LLP, 1800 Alexander Bell Drive, SUITE 200, Reston, VA, 20191, US

(73) Assignee: SHARP KABUSHIKI KAISHA, Osaka-shi, Osaka (JP)

(21) Appl. No.: 12/300,489

(22) PCT Filed: Mar. 7, 2007
(86) PCT No.: PCT/JP2007/054384

§ 371 Date: Nov. 12, 2008

(30) Foreign Application Priority Data
Jul. 18, 2006 (JP) 2006-196077

(51) Int. Cl. G02F 1/1335; G02F 1/1333

(52) U.S. Cl. 349/58; 349/106; 349/110

(57) ABSTRACT

A liquid crystal display panel displays an image on a curved display surface, in which light leakage through a space between pixel electrodes is reliably prevented. The liquid crystal display panel includes an active matrix substrate having the pixel electrodes, an opposed substrate having a common electrode arranged to generate a potential difference between the common electrode and each pixel electrode, a liquid crystal layer sandwiched between the substrates and arranged to control a light transmission state in accordance with the potential difference, and a black matrix arranged to prevent light leakage through a space between the pixel electrodes. The black matrix is provided on a liquid crystal layer side on the active matrix substrate.

### BACKGROUND OF THE INVENTION

1. Field of the Invention

The present invention relates to a liquid crystal display panel capable of displaying an image on its display surface, which is curved.

2. Description of the Related Art

Development of liquid crystal display devices (curved surface displays) that have a curved display surface and are capable of realizing curved surface image display has advanced in recent years.

For example, when using a liquid crystal display device as a curved surface display, such as is disclosed in Japanese Unexamined Patent Application Publication, Tokukai-hei, No. H3-157620 (published on Jul. 5, 1991), a liquid crystal cell is formed by sandwiching liquid crystal between two substrates having transparent conducting layers, wherein one of the substrates is formed of an elastic planar body made from a polymer material and having a thickness of 0.2 mm to 1 mm, and the other of the substrates is formed of a flexible film made from a polymer material and having a thickness of 0.15 mm or less. By using this arrangement, the liquid crystal display device reduces deflection and folds caused at a time of cell processing.

An arrangement in which a color filter (CF) is formed on an active matrix substrate is also known in the field of liquid crystal display devices, though there is no direct relation between such an arrangement and a curved surface display. Such an arrangement is disclosed in Japanese Unexamined Patent Application Publication, Tokukai-hei, No. 2002-365614 (published on Dec. 18, 2002) (corresponding Specification of US Patent No. US 2002/0182766 A1 (published on Dec. 5, 2002)), Japanese Unexamined Patent Application Publication, Tokukai-hei, No. H4-253028 (published on Sep. 8, 1992), and Japanese Unexamined Patent Application Publication, Tokukai-hei, No. H2-54217 (published on Feb. 23, 1990), for example.

One problem associated with an image displayed on a liquid crystal display panel including a curved surface display occurs when a viewer O watches a liquid crystal display panel 1″ squarely from a front side, as shown in FIG. 14. Ordinarily, a distance between the viewer O and the liquid crystal display panel 1″ is sufficiently long with respect to a viewing angle V at the time when the viewer O watches the liquid crystal display panel 1″. Thus, directions of visual axes of the viewer O (indicated by the arrows in FIG. 14) are considered almost parallel to each other at arbitrary positions on the liquid crystal display panel 1″.

As shown in FIG. 9A, a direction of a visual axis indicated by the arrows corresponds to a direction of a normal line of the liquid crystal display panel 1″ in the vicinity of a center of the liquid crystal display panel 1″. Thus, a black matrix 41, formed on an opposed substrate 10″ (a color filter loading substrate, a CF substrate) of the liquid crystal panel 1″, (i) overlaps with a space between pixel electrodes 51 on an active matrix substrate 20″, and (ii) serves properly to hide the space from the viewer O (see FIG. 14)

However, as shown in FIG. 9B, a direction of a visual axis becomes diagonal to the liquid crystal display panel 1″ in an end portion of the liquid crystal display panel 1″, since a display surface is curved. Because of this, in the end portion of the liquid crystal display panel 1″, the black matrix 41 formed on the substrate 10″ cannot hide the space between pixel electrodes 51 on the active matrix substrate 20″.

When the black matrix 41 cannot hide the space between the pixel electrodes 51 in the visual axis of the inclined direction, as described above, it is not possible to make the black matrix 41 hide a light blocking material such as a source line 21s or the like arranged in the space. This causes apparent aperture rate deterioration and light leakage through a space between the light blocking material and a pixel electrode 51.

### SUMMARY OF THE INVENTION

Preferred embodiments of the present invention have been made in the view of the above problems, and provide a liquid crystal display panel capable of displaying an image on a curved display surface that prevents aperture rate deterioration and light leakage, each of which results from a space between the pixel electrodes.

A liquid crystal display panel according to a preferred embodiment of the present invention is a liquid crystal display panel capable of displaying an image on a curved display surface including (i) a first substrate having a plurality of pixel electrodes that are arranged in a two-dimensional matrix configuration, (ii) a second substrate having a common electrode arranged to generate a potential difference between the common electrode and each of the pixel electrodes, (iii) a liquid crystal layer sandwiched between the substrates and arranged to control a light transmission state in accordance with the potential difference, and (iv) a black matrix arranged to cover and hide a space between the pixel electrodes. The black matrix is provided on a surface of the first substrate that opposes the liquid crystal layer.

In a conventional liquid crystal display panel with a curved display surface, the black matrix arranged to cover and hide the space between the pixel electrodes from a viewer is arranged on a second substrate having the common electrode arranged to generate a potential difference between the common electrode and each of the pixel electrodes.

In such a conventional arrangement, if a positional relationship between (i) the space between the pixel electrodes and (ii) the black matrix is set such that they overlap each other when viewed from the direction of the normal line of the display surface, the black matrix serves properly to cover and hide the space between the pixel electrodes in the direction of the normal line of the display surface.

However, in the case of the liquid crystal display panel having a curved display surface, a portion of the display surface is viewed from a diagonal or substantially diagonal direction. Since there is a gap corresponding to a layer thickness of the liquid crystal layer, between each of the pixel electrodes and the black matrix, the black matrix cannot cover the space between the pixel electrodes when the display surface is viewed from a diagonal or substantially diagonal direction. As a result, the light blocking member, such as a source line or the like arranged in the space, causes an apparent aperture rate to be deteriorated, and a light leakage is caused in the space between the light blocking member and a pixel electrodes.

On the other hand, in the above arrangement according to a preferred embodiment of the present invention, the black matrix is formed on a liquid crystal layer side of the first substrate that has the pixel electrodes. Because of this, there is no gap between each of the pixel electrodes and the black matrix. This allows the black matrix to cover and hide the space between the pixel electrodes in an arbitrary direction. As a result, it is possible to prevent the aperture rate deterioration and the light leakage that result from the space between the pixel electrodes.

As described above, a preferred embodiment of the present invention focuses on the problems specific to liquid crystal display panels capable of displaying images on a curved display surface. A preferred embodiment of the present invention solves the problems by adopting the unique arrangement in which the black matrix is provided on the surface of the first substrate that opposes the liquid crystal layer, in this liquid crystal panel.

It is preferable that the liquid crystal display panel according to a preferred embodiment of the present invention additionally includes a color filter arranged to color light that passes through the liquid crystal layer, the color filter being provided on the surface of the first substrate that opposes the liquid crystal layer.

In an arrangement according to a preferred embodiment of the present invention, both the black matrix and the color filter are arranged on the liquid crystal layer side of the first substrate that has the pixel electrodes. As a result, there is no direction of a visual axis that passes through a color filter for one pixel and also passes through a pixel electrode for a neighboring pixel of a different color (see FIG. 11B). Thus, it is possible to prevent generation of color mixture.

In an arrangement according to a preferred embodiment of the present invention, it is possible to dispose the black matrix and the color filter between the active matrix substrate and each of the pixel electrodes.

It is preferable that the liquid crystal display panel according to a preferred embodiment of the present invention is arranged such that the black matrix has a film thickness that is thinner than a film thickness of the color filter, in the liquid crystal display panel.

Generally, the film thickness of the black matrix is often set to be equal to that of the color filter. However, in the liquid crystal display panel capable of displaying images on a curved display surface, a portion of the display surface is viewed diagonally. In this case, the film thickness of the black matrix becomes a cause of the apparent aperture rate deterioration.

As such, in the above arrangement according to a preferred embodiment of the present invention, the black matrix has the film thickness that is thinner than that of the color filter. Accordingly, it is possible to prevent the apparent aperture rate deterioration.

It is preferable that the liquid crystal display panel according to a preferred embodiment of the present invention is arranged such that each of the substrates has flexibility, in the liquid crystal display panel.

In an arrangement according to a preferred embodiment of the present invention, it is possible to display images on the curved display surface by using the flexibility of the substrates. It is preferable to have a degree of flexibility that allows the substrates to be curved so as to have a radius of curvature of, for example, approximately 200 mm, without being broken. When a glass substrate is used, it is preferable that a thickness thereof is set to about 0.3 mm or less, for example.

It is preferable that the liquid crystal display panel according to a preferred embodiment of the present invention includes a fixing frame arranged to maintain each of the substrates in the liquid crystal display panel in a desired curved condition.

In an arrangement according to a preferred embodiment of the present invention, it is possible to realize the curved surface display by arranging the fixing frames so as to maintain each of the substrates in the desired curved condition.

The liquid crystal display panel according to a preferred embodiment of the present invention has, as described above, (i) the first substrate having the plurality of the pixel electrodes that are arranged in a two-dimensional matrix configuration, (ii) the second substrate having the common electrode arranged to generate the potential difference between the common electrode and each of the pixel electrodes, (iii) the liquid crystal layer sandwiched between the substrates and controlling the light transmission state in accordance with the potential difference, and (iv) the black matrix arranged to prevent the light leakage through the space between the pixel electrodes, the black matrix being provided on that surface of the first substrate, which faces the liquid crystal layer.

In an arrangement according to a preferred embodiment of the present invention, the black matrix is provided on the liquid crystal layer side of the first substrate that has the pixel electrodes. As a result, there is no gap between each of the pixel electrodes and the black matrix. This allows the black matrix to properly cover and hide the space between the pixel electrodes, in the arbitrary direction. As a result, it is possible to reliably prevent aperture rate deterioration and light leakage that result from the space between the pixel electrodes.

Other features, elements, steps, characteristics and advantages of the present invention will become more apparent from the following detailed description of preferred embodiments of the present invention with reference to the attached drawings.

### BRIEF DESCRIPTION OF THE DRAWINGS

FIG. 1 is a block diagram showing an arrangement of a curved surface display of a preferred embodiment in accordance with the present invention.

FIG. 2 is a plan view for showing an arrangement of a pixel of a liquid crystal display panel of the curved surface display in FIG. 1.

FIG. 3 is a cross-sectional view taken across A-A in FIG. 2.

FIG. 4 is a cross-sectional view showing a preferred embodiment of an active matrix substrate shown in FIG. 2.

FIG. 5 is a cross-sectional view showing another preferred embodiment of the active matrix substrate shown in FIG. 2.

FIG. 6 is a cross-sectional view showing still another preferred embodiment of the active matrix substrate shown in FIG. 2.

FIG. 7 shows an arrangement that maintains a curved condition of the liquid crystal display panel including the curved surface display in FIG. 1.

FIG. 8A is a cross-sectional view showing an exemplary curved condition of the liquid crystal display panel including the curved surface display in FIG. 1.

FIG. 8B is a cross-sectional view showing another exemplary curved condition of the liquid crystal display panel including the curved surface display in FIG. 1.

FIG. 8C is a cross-sectional view showing still another exemplary curved condition of the liquid crystal display panel including the curved surface display in FIG. 1.

FIG. 8D is a cross-sectional view showing yet another exemplary curved condition of the liquid crystal display panel including the curved surface display in FIG. 1.

FIG. 9A is a cross-sectional view of a liquid crystal display panel of a comparative example, showing a relation between a direction of a visual axis and an arrangement of each section of the liquid crystal panel in a portion viewed from a direction of a panel normal line.

FIG. 9B is a cross-sectional view of the liquid crystal display panel of the comparative example, showing a relation between a direction of a visual axis and an arrangement of each section of the liquid crystal display panel in a portion viewed from a direction diagonal to the panel.

FIG. 10A is a cross-sectional view of a preferred embodiment of a liquid crystal display panel including the curved surface display in FIG. 1, showing a relation between a direction of a visual axis and an arrangement of each section of the liquid crystal display panel in a portion viewed from the direction of the panel normal line.

FIG. 10B is a cross-sectional view of a preferred embodiment of the liquid crystal display panel including the curved surface display in FIG. 1, showing a relation between a direction of a visual axis and an arrangement of each section of the liquid crystal display panel in a portion viewed from the direction diagonal to the panel.

FIG. 11A is a cross-sectional view of a preferred embodiment of the liquid crystal display panel including the curved surface display in FIG. 1, showing a relation between a direction of visual axis and an arrangement of each section of the liquid crystal display panel in a portion viewed from the direction of the panel normal line.

FIG. 11B is a cross-sectional view of the liquid crystal display panel including the curved surface display in FIG. 1, a relation between the direction of a visual axis and an arrangement of each section of the liquid crystal display panel in a portion viewed from the direction diagonal to the panel.

FIG. 12 is a drawing of a preferred embodiment of the liquid crystal display panel including the curved surface display in FIG. 1, showing an angle between a plane perpendicular or substantially perpendicular to a direction of a visual axis and a tangent plane of the liquid crystal display panel, at a viewing point.

FIG. 13 is a cross-sectional view of two liquid crystal display panels having black matrixes whose film thicknesses are different from each other, showing a relation between the direction of a visual axis and an arrangement of each section of the liquid crystal display panel in a portion viewed from the direction diagonal to the panel, respectively.

FIG. 14 is a cross-sectional view showing relations between a curved surface display and directions of visual axes.

### DETAILED DESCRIPTION OF THE PREFERRED EMBODIMENTS

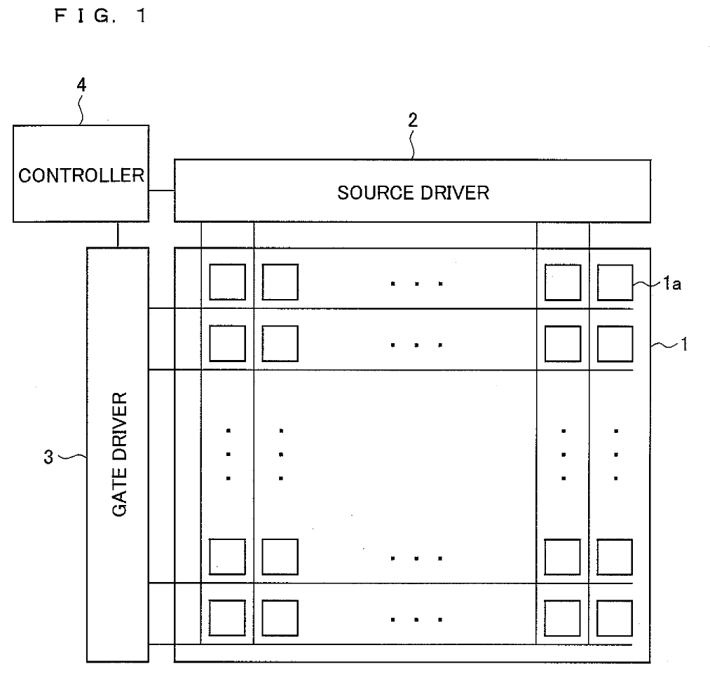

The following description explains preferred embodiments of the present invention, with reference to FIGS. 1 through 13. The present preferred embodiment deals with a curved surface display having a curved display surface.

As shown in FIG. 1, the curved display surface of the present preferred embodiment includes a liquid crystal display device having a liquid crystal display panel 1 that has a plurality of pixels 1a arranged in a matrix configuration, a source driver 2 and a gate driver 3 that drive the liquid crystal display panel 1, and a controller 4 that controls the source driver 2 and the gate driver 3 by transmitting various signals thereto.

Conventional drivers and controllers can be used as the source driver 2, gate driver 3, and controller 4, respectively. Thus, explanations thereof will be omitted.

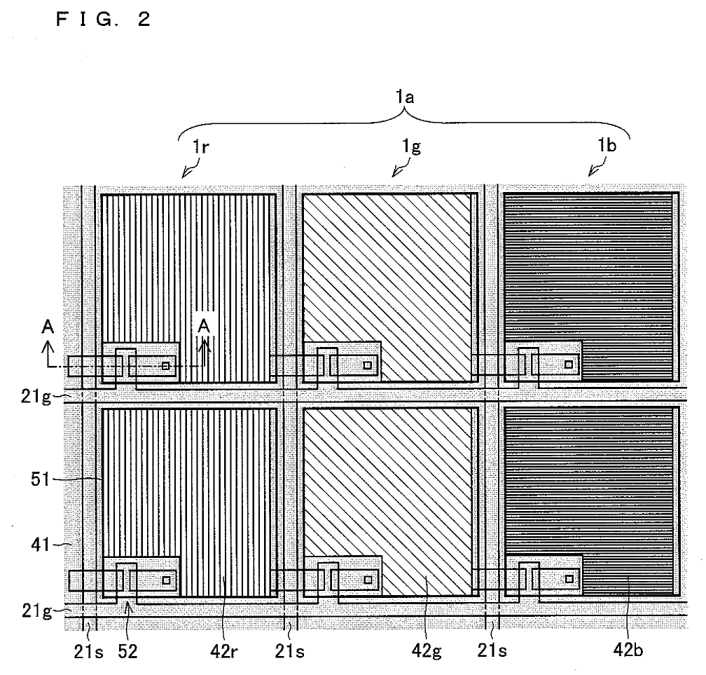

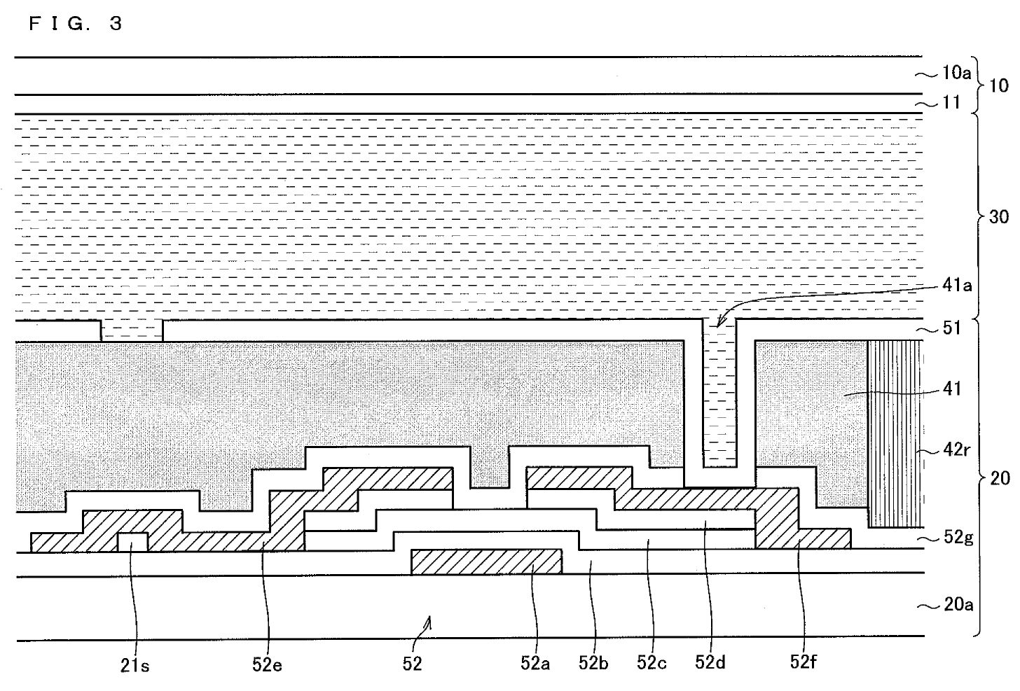

With reference to FIGS. 2 and 3, a preferred embodiment of the liquid crystal display panel 1 is explained as follows. Here, FIG. 2 is a plan view of the liquid crystal display panel 1, and FIG. 3 is a cross-sectional view taken across A-A in FIG. 2. For the sake of simplicity, some display elements are not illustrated in FIG. 2.

The liquid crystal display panel 1 has an opposed substrate 10 and an active matrix substrate 20 that oppose each other and a liquid crystal layer 30 that is sandwiched therebetween.

The opposed substrate 10 has a common electrode 11 on a surface of a substrate body 10a, the surface opposes the liquid crystal layer 30. The common electrode 11 is arranged to extend across almost the entire surface of the opposed substrate 10, and serves as a common counter electrode to each of the pixels 1a.

The active matrix substrate 20 has a plurality of source lines 21s and a plurality of gate lines 21g, on a surface of a substrate body 20a, the surface opposes the liquid crystal layer 30. The source lines 21s extend in a lengthwise direction of the liquid crystal display panel 1 (hereinafter, simply referred to as “a lengthwise direction”) and are provided parallel or substantially parallel to each other at regular intervals. The gate lines 21g extend in a crosswise direction of the liquid crystal display panel 1 (hereinafter, simply referred to as “a crosswise direction”) and are provided parallel or substantially parallel to each other at regular intervals. The pixels 1a are formed from a plurality of regions (hereinafter, referred to as “pixel regions”) that are sectioned by the source lines 21s and the gate lines 21g.

The pixels 1a are categorized into pixels 1r, 1g, and 1b that transmit light of red (R), green (G), and blue (B) colors, respectively. The pixels 1r, 1g, and 1b are arranged sequentially and repeatedly in the crosswise direction, whereas they are arranged in the lengthwise direction so as to align in the single colors.

Arrangements of the pixels 1a are explained as follows. Each pixel 1a has a pixel electrode 51 made from a transparent conductor and a thin film transistor (hereinafter, referred to as “TFT”) 52 that switches between the source line 21 and the pixel electrode 51 in accordance with a gate signal transmitted by the gate line 21g.

The pixel electrode 51 is arranged so as to cover almost the entire pixel region. The pixel electrode 51 generates a potential difference with the common electrode 11 therebetween, in accordance with a source signal transmitted by the source line 21s, to control orientation of liquid crystal in a region of the liquid crystal layer 30 corresponding to the pixel electrode 51. Thus, the pixel electrode 51 controls a light transmission amount, with the action of deflecting plates (which are not illustrated) provided on external surfaces of the opposed substrate 10 and the active matrix substrate 20, respectively.

In the vicinity of an intersection of the source line 21s and the gate line 21g, the TFT 52 is arranged below the pixel electrode 51 and on the surface of the substrate body 20a. The TFT 52 has a configuration in which a gate electrode 52a, gate insulation film 52b, semiconductor layer 52c, n⁺ layer 52d, source electrode 52e, drain electrode 52f, and protective film 52g. The gate electrode 52a is arranged as a portion of the gate line 21g. The source electrode 52a is connected to the source line 21s, and the drain electrode 52f is connected to the pixel electrode 51. Among them, the gate insulation film 52b and the protective film 52g are arranged not only in a TFT 52 region but also arranged across almost the entire surface of the active matrix substrate 20.

The active matrix substrate 20 further includes a black matrix 41 and a color filter 42 (in the present specification, the “color filter” refers to a color layer arranged to color the transmissive light, but does not include the black matrix). In FIGS. 2 and 3, the black matrix 41 is indicated by a gray tone, whereas color filters 42r, 42g, and 42b for R, G, and B are indicated by vertical, diagonal, and horizontal hatching regions, respectively.

The black matrix 41 and the color filters 42 are provided as a layer provided between the pixel electrode 51 and the protective film 52g in the active matrix substrate 20. On the black matrix 41, a contact hole 41a is provided. Each of the pixel electrodes 51 and the drain electrode 52f are interconnected to each other via the contact hole 41a.

The black matrix 41 is arranged to prevent light leakage through a space between the pixel electrodes 51. The black matrix 41 is also provided to prevent reflection of outside light by the source line 21s, gate line 21g, and TFT 52 that are made from a metal or the like having a high reflectance. As such, the black matrix 41 is provided in the space between the pixel electrodes 51 as well as in the TFT 52 region.

The color filter 42 is arranged away from the region where the black matrix is provided. That is, of the region where the pixel electrode 51 is provided, the color filter 42 is provided except in the TFT 52 region. As such, a display region in the active matrix substrate 20 is covered by the black matrix 41 or the color filter 42. The region where the color filter 42 is provided becomes an effective region of the respective pixels.

As such, the active matrix substrate 20 includes the black matrix 41 and the color filter 42.

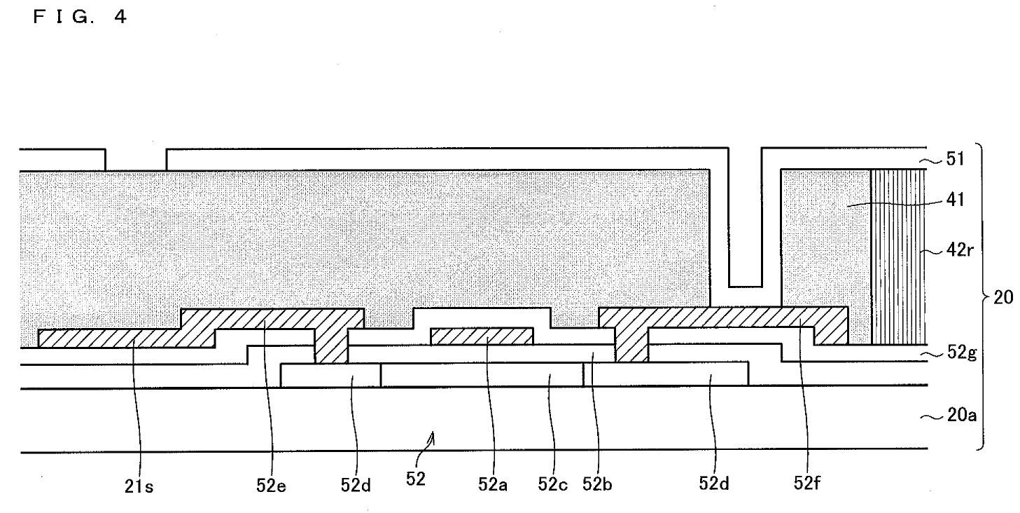

The preferred embodiment of an active matrix substrate 20 shown in FIG. 3 is a bottom gate arrangement in which the gate electrode 52a is provided below the semiconductor layer 52c. Alternatively, the active matrix substrate 20 may be arranged in a top gate arrangement in which a gate electrode 52a is provided above a semiconductor layer 52c, as shown in FIG. 4.

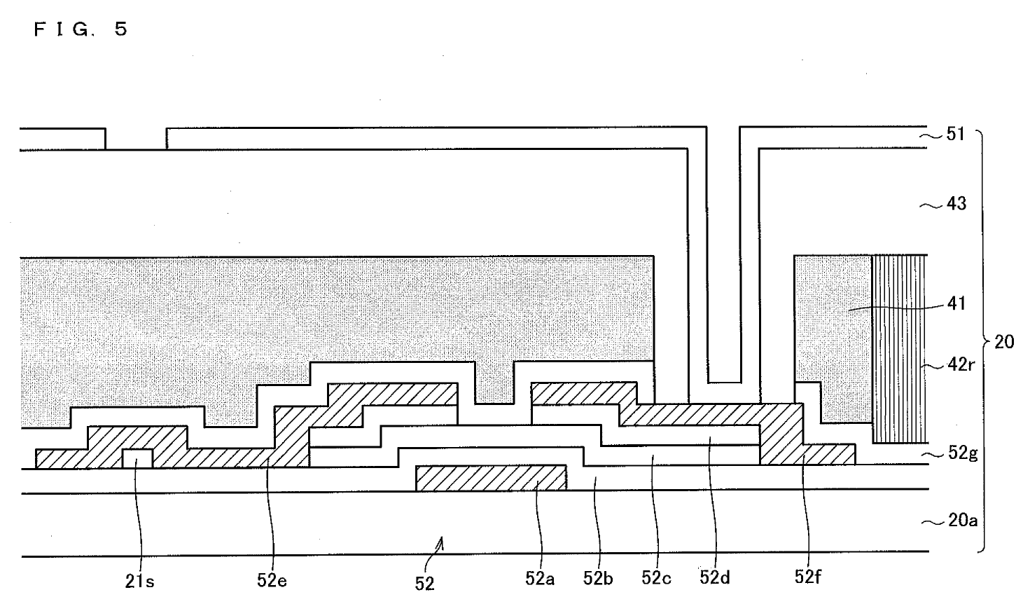

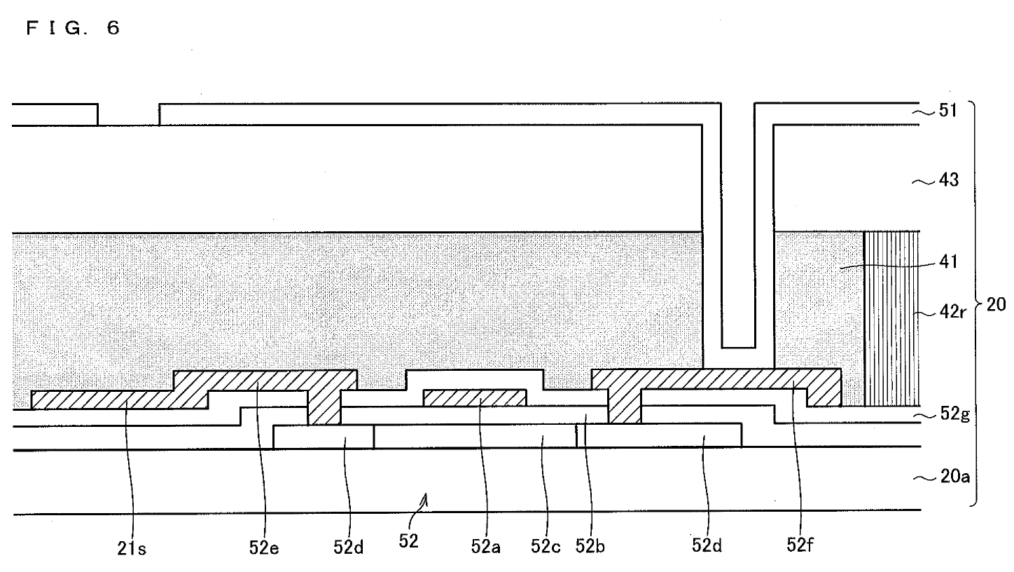

As shown in FIGS. 5 and 6, an overcoat layer 43 arranged to improve flatness may be provided on the black matrix 41 and the color filter 42 either in the bottom gate arrangement or the top gate arrangement.

The liquid crystal display panel 1 according to a preferred embodiment has flexibility because the substrate body 10a of the opposed substrate 10 and the substrate body 20a of the active matrix substrate 20 are formed from a thin resin material, respectively, whose thickness is approximately 1 mm or less or from a thinner glass material. By this, it is possible to display an image on the display surface of the liquid crystal display device 1 being curved.

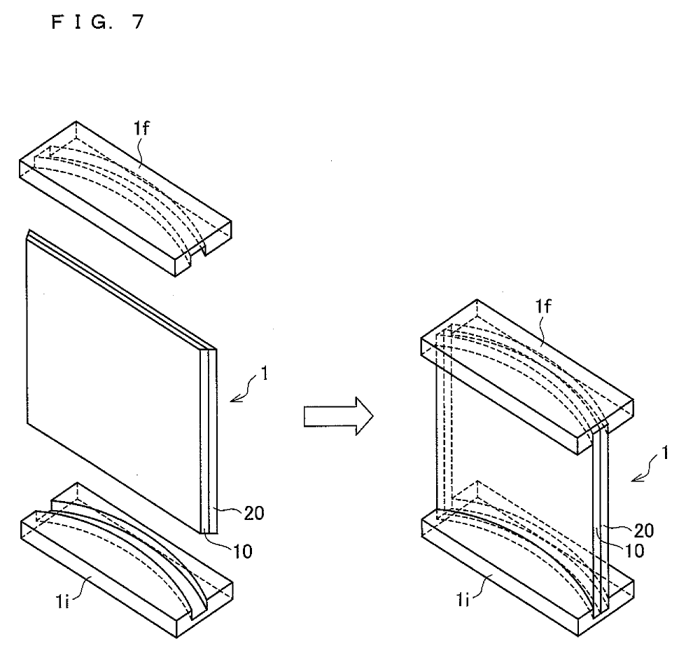

Furthermore, in order to maintain a desired curved condition, the liquid crystal display panel 1 is fixed with a pair of fixing frames 1f and 1i, as shown in FIG. 7. The fixing frames 1f and 1i have trenches (i) into which the upper hem and lower hem of the liquid crystal display panel 1 are set, respectively, and (ii) which thus make a predetermined curvature across the upper hem and lower hem. As such, the liquid crystal display panel 1 can maintain the desired curved condition by setting the upper and lower hems into the trenches of the fixing frames 1f and 1i, respectively. The curvature should be set up as appropriate based on use and the like of the liquid crystal display panel 1. The curvature is set preferably to about 100 mm or larger, for example. Thus, for example, the curvature can be set at approximately 200 mm.

The above description deals with a case in which the upper and lower hems of the liquid crystal display panel 1 are fixed with the fixing frames 1f and 1i. Alternatively, only four corners of the liquid crystal display panel 1 may be fixed such that the desired curved condition is maintained.

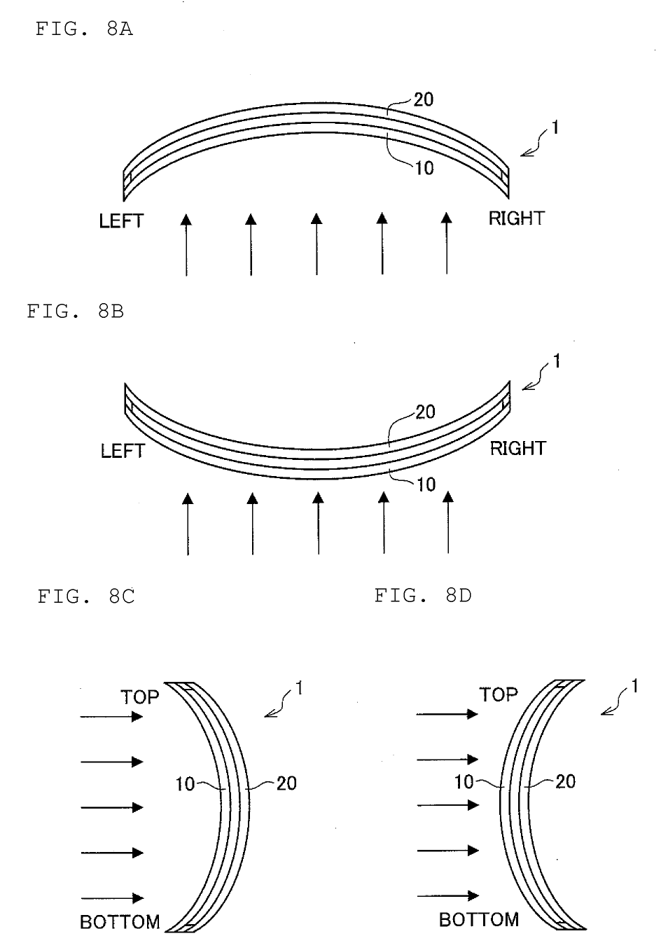

Besides, the above description assumes that the display surface becomes a recessed surface and is curved to have the curvature in a lateral direction (see FIG. 8A). Alternatively, the display surface may be curved to become a convex surface (see FIG. 8B) or curved to have the curvature in a vertical direction (see FIGS. 8C and 8D).

Furthermore, the above description deals with a case where the opposed substrate 10 is a display surface. Alternatively, the active matrix substrate 20 may be the display surface. However, it is necessary in such an arrangement to form the source line 21s, gate line 21g, and TFT 52 from a low reflecting material(s) in order to prevent them from reflecting the outside light.

Next, a method for manufacturing a preferred embodiment of a liquid crystal display panel 1 will be explained.

The opposed substrate 10 can be manufactured by forming, on the transparent and flexible substrate body 10a, an ITO film that has a film thickness of approximately about 100 nm to about 200 nm, for example, across the almost entire surface of the opposed substrate 10.

On the other hand, a method for manufacturing the active matrix substrate 20 can be described as follows. Here, the following description basically deals with the case of the bottom gate arrangement that is shown in FIGS. 3 and 5.

On the transparent substrate body 20a, patterns made from titanium (Ti), aluminum (Al), chrome (Cr) or aluminum base alloy and having a film thickness of about 200 nm to about 400 nm are formed as the gate lines 21s and the gate electrode 52a.

On the gate lines 21s and the gate electrode 52a, a film made of a nitride film (SiNₓ) and having a film thickness of about 200 nm to about 400 nm is formed, as a gate insulation film 52b, across the almost entire surface of the active matrix substrate 20.

On the gate insulation film 52b, (i) a pattern made from an a-Si (amorphous silicon) film and having a film thickness of about 60 nm to about 200 nm and (ii) a pattern made from an n⁺-Si film and having a film thickness of about 50 nm to about 100 nm are formed as the semiconductor layer 52c and the n⁺ layer 52d, respectively.

Furthermore, patterns made from titanium (Ti), aluminum (Al), chrome (Cr), or aluminum base alloy and having a film thickness of about 150 nm to about 300 nm are formed as the source electrodes 52e, drain electrodes 52f, and source lines 21s.

On top of the source electrodes 52e, drain electrodes 52f, and source lines 21, a film made of a nitride film (SiNₓ) and having a film thickness of about 200 nm to about 400 nm is formed as the protective film 52g across the almost entire surface of the active matrix substrate 20.

Then, the black matrix 41 having a film thickness of about 1 μm to about 3 μm is formed in a predetermined region on the protective film 52g, i.e., a space region between the pixel electrodes 51 and the TFTs 52 forming region. The color filter 42 having the same film thickness of about 1 μm to about 3 μm is formed on another region. The black matrix 41 and the color filter 42 can be formed by using a colored resist method, ink-jet method, electrodeposition method, dry film method, or the like.

In addition, if necessary, an acrylic transparent resin having a film thickness of about 1 μm to about 3 μm may be formed, as the overcoat layer 43 for improving flatness, on the black matrix 41 and the colored filter 42.

On the black matrix 41 and the colored filter 42 or on the overcoat layer 43, a pattern made of the ITO (Indium Tin Oxide) film and having a film thickness of approximately 100 nm is formed as the pixel electrode 51. The contact hole 41a is formed on the protective layer 52g, the black matrix 41 and the colored filter 42, and/or the overcoat layer 43, before forming the pixel electrode 51.

Also, though not illustrated in FIGS. 3 and 5, a pattern of a resin columnar spacer having a height of about 3 μm to about 5 μm (PS: Post spacer) may be formed from an acrylic resin, if necessary. The resin columnar spacer serves as a spacer for maintaining the gap between the opposed substrate 10 and the active matrix substrate 20.

The opposed substrate 10 and the active matrix substrate 20 thus manufactured as described above (i) are arranged to oppose each other such that the common electrode 11 and the pixel electrodes 51 are inwardly positioned, respectively, and then (ii) are bound with each other. In this case, it is unnecessary to perform position alignment for aligning each of the pixel electrodes 51 with the black matrix 41 and the colored filter 42 as in the case of the conventional arrangement. Thus, the process can be easier.

Then, liquid crystal is introduced between the opposed substrate 10 and the active matrix substrate 20, and the substrates are sealed. By this, the liquid crystal display panel 1 that is curved is manufactured. In a case that a plurality of the liquid crystal display panels 1 are manufactured from a single substrate formed by bonding the opposed substrate 10 with the active matrix substrate 20, the bound substrate is fractionalized into the panels before introducing the liquid crystal.

Then, the liquid crystal display panel 1 is curved to fit into the trenches of the fixing frames 1f and 1i shown in FIG. 7, and the upper and lower hems of the liquid crystal display panel 1 are set into the trenches, respectively. Finally, the manufacture of the liquid crystal display panel 1 is completed.

In a case in which the substrate bodies 10a and 20a are glass substrates, suitable flexibility can be obtained through thinning the substrates bodies 10a and 20a down to about 0.01 mm to about 0.3 mm by chemical etching or mechanical polishing after bonding the opposed substrate 10 with the active matrix substrate 20.

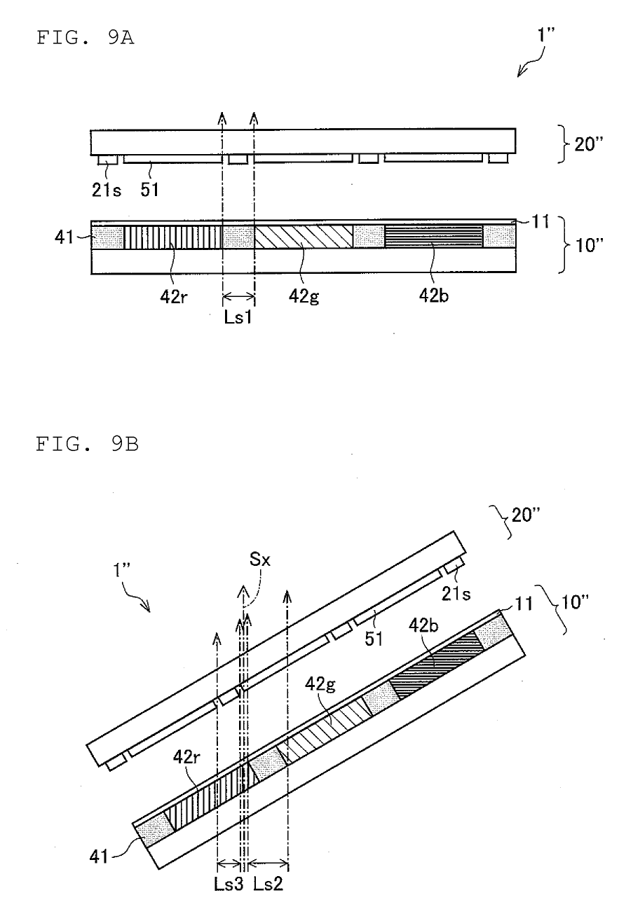

Next, a reason why light leakage can be prevented by the liquid crystal display panel 1 is explained, with reference to FIGS. 9A through 11B. For the simple drawings, some of display elements are not illustrated in FIGS. 9A through 11B.

The following description deals with a case in which a viewer squarely watches the liquid crystal panel from a front side.

For comparison, the following description first explains a liquid crystal display panel 1″ that is arranged such that a black matrix 41 and a color filter 42 are formed not in an active matrix substrate 20″ side but in an opposed substrate 10″ side.

As shown in FIG. 9A, in the vicinity of a center of the liquid crystal display panel 1″, a direction of a visual axis indicated by the arrows corresponds to a direction of a normal line of the liquid crystal display panel 1″.

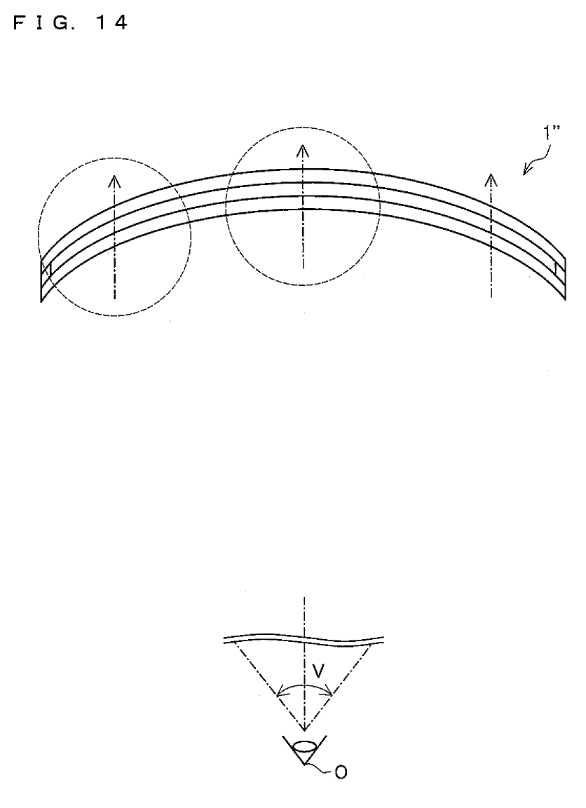

As such, the black matrix 41 on the opposed substrate 10″ (color filter loading substrate, CF substrate) of the liquid crystal display panel 1″ overlaps with a space (the space that includes a portion where source lines 21s are provided) between pixel electrodes 51 on the active matrix substrate 20″. Thus, the black matrix serves properly to hide the space between the pixel electrodes 51 from a viewer O (see FIG. 14). A non-aperture region of the liquid crystal display panel 1″ has a width of Ls1, which corresponds to a width of the black matrix 41 in a surface direction of the opposed substrate 10″.

However, as shown in FIG. 9B, the direction of a visual axis becomes diagonal to a display surface of the liquid crystal display panel 1″ in the vicinity of an end portion of the liquid crystal display panel 1″, since the display surface is a curved surface.

As such, the black matrix 41 does not overlap with the space between the pixel electrodes 51. Thus, the black matrix 41 cannot hide the space between the pixel electrodes 51 from the viewer O. The non-aperture region of the liquid crystal display panel 1″ has a width corresponding to a sum of (i) a light blocking width Ls2 blocked by the black matrix 41 and (ii) a light blocking width Ls3 blocked by each of the source lines 21s. Thus, an aperture rate deteriorates. Furthermore, there may be a direction of a visual axis Sx that, for example, passes through a color filter 42r for R and also passes through a pixel electrode 51 for G, a neighboring pixel of the color filter 42r for R. Thus, a color mixture is possibly caused.

Generation of the light blocking width Ls3 that is provided by each of the source lines 21s is presupposed on the assumption that the source lines 21s are provided by a light blocking member. However, if the source lines 21s are formed from a transparent member, light passing through this region passes through the space between the pixel electrodes 51, thereby resulting in that control over a transmission amount is not fully performed. Thus, the light leakage is caused.

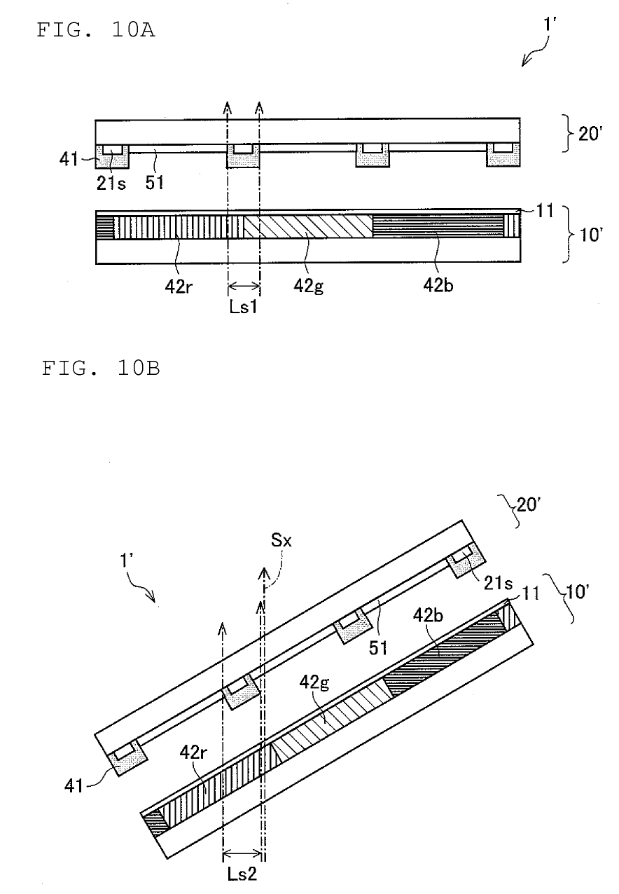

In contrast, the aperture rate deterioration can be prevented in a liquid crystal display panel 1′ in which the black matrix 41 is formed on an active matrix substrate 20′, i.e., provided in a space between pixel electrodes 51 on the active matrix substrate 20′, as shown in FIGS. 10A and 10B.

That is, when the black matrix 41 is provided in an active matrix substrate 20′ side, a light blocking width blocked by each of the source lines 21s is covered within a light blocking width Ls2 blocked by the black matrix 41. Thus, a width of the non-aperture region in the liquid crystal display panel 1′ corresponds solely to the light blocking width Ls2 blocked by the black matrix 41.

As such, in view of the prevention of the aperture rate deterioration, the arrangement in which the black matrix 41 is provided in the active matrix substrate 20′ side may be adopted. Thus, the arrangement corresponds to a preferred embodiment of the present invention.

However, since the color filter 42 is provided in an opposed substrate 10′ side in the liquid crystal display panel 1′, there may be a direction of a visual axis Sx that, for example, passes through a color filter 42r for R and also passes through a pixel electrode 51 for G, a neighboring pixel of the color filter 42r for R. Thus, the color mixture is possibly generated.

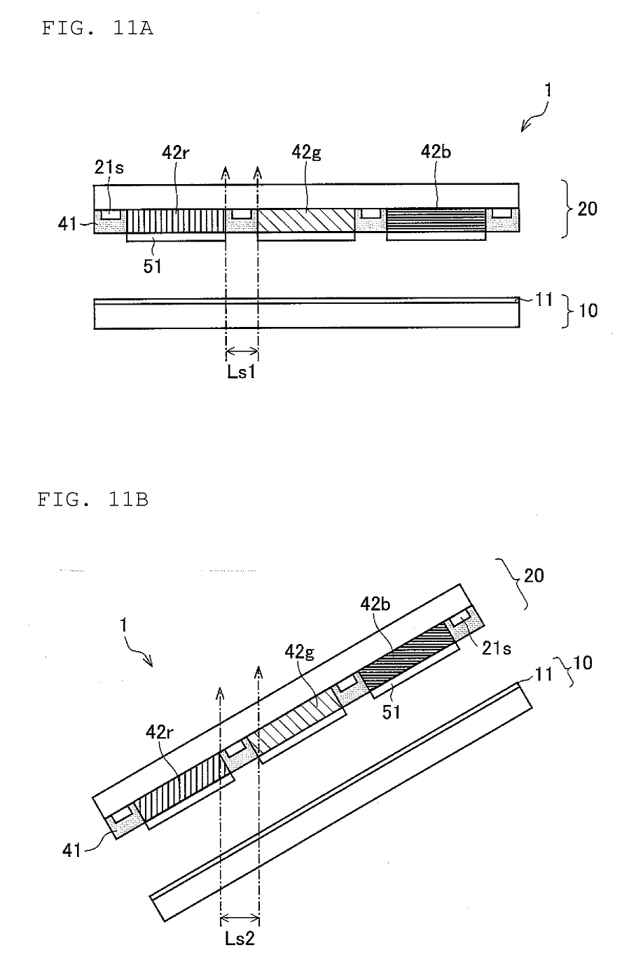

In contrast, it is possible to prevent the aperture rate deterioration and to avoid the color mixture, in the liquid crystal display panel 1 in which a black matrix 41 and a color filter 42 are provided on an active matrix substrate 20, as shown in FIGS. 11A and 11B.

That is, a width of a non-aperture region in the liquid crystal display panel 1, as in the liquid crystal display panel 1′, corresponds to solely a light blocking width Ls 2 blocked by the black matrix 41. Thus, it is possible to prevent the aperture rate deterioration. Besides, since the color filter 42 and the pixel electrodes 51 are provided on the single substrate, there does not exist the direction of the visual axis Sx, shown in FIG. 10B, that passes through the color filter 42r for R and also passes through the pixel electrode 51 for G, a neighboring pixel of the color filter 42r for R. Thus, it is possible to avoid the color mixture.

Furthermore, it is necessary in the liquid crystal display panel 1′ to align the black matrix 41 to the color filter 42 when bonding the opposed substrate 10′ with the active matrix substrate 20′, whereas it is not necessary to perform the alignment of the liquid crystal display panel 1. Thus, the misalignment that may be caused when bonding the substrates can be ignored.

As such, the liquid crystal display panel 1 sets out to avoid the color mixture through the disposition of the black matrix 41 and color filter 42. Thus, it is possible to avoid the color mixture without widening the width of the black matrix 41.

In fact, the width of the black matrix can be narrowed down approximately by about 3 μm to about 6 μm and the aperture rate can be raised approximately by about 2% to about 5% in the arrangement in which the black matrix and the color filter are provided on the active matrix substrate, as compared to the arrangement in which the black matrix and the color filter are provided on the opposed substrate.

As described above, it is possible to prevent the aperture rate deterioration and to avoid the color mixture in the liquid crystal display panel 1, and thus, it is possible to make display quality more suitable.

Now, the following description further discusses the aperture rate of the liquid crystal display panel 1. As shown in FIGS. 11A and 11B, in the liquid crystal display panel 1, the width Ls2 of the non-aperture region in the vicinity of the end portion is wider than the width Ls1 of the non-aperture region in the vicinity of the center. Thus, the apparent aperture rate deteriorates more in the vicinity of the end portion of the liquid crystal display panel, as compared to the vicinity of the center of the liquid crystal display panel.

A difference (Ls2−Ls1) between the width Ls2 in the vicinity of the end portion of the liquid crystal display panel 1 and the width Ls1 of the non-aperture region in the center of the liquid crystal display panel is expressed by:

$$( Ls 2 - Ls 1 ) = ( Ls 1 + d \times tan θ ) \times cos θ - Ls 1 \\ = ( cos θ - 1 ) \times Ls 1 + d \times sin θ .$$

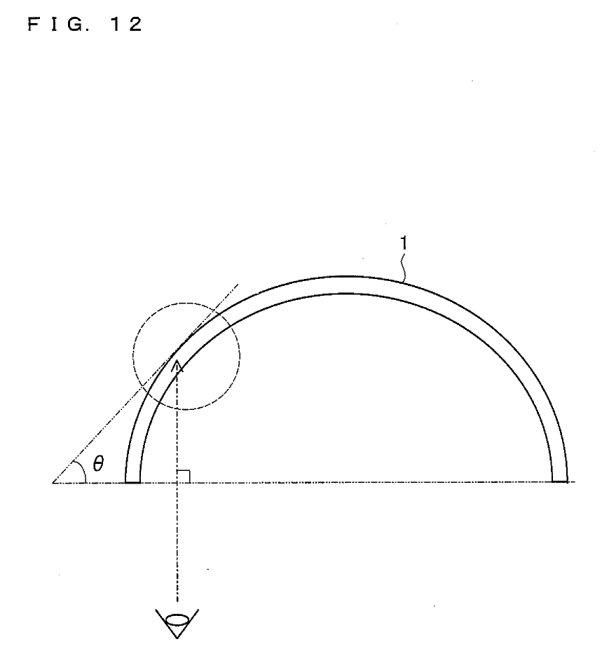

Here, d is a film thickness of the black matrix 41 and θ is an angle (an angle of a gradient of the display surface), as shown in FIG. 12, between (i) a plane perpendicular or substantially perpendicular to a direction of a visual axis and (ii) a tangent plane of the liquid crystal display panel, at the viewing point. Also, the width Ls 1 in the non-aperture region in the vicinity of the center of the liquid crystal display panel 1 is equal to the width of the black matrix 41 in the surface direction of the opposed substrate 10.

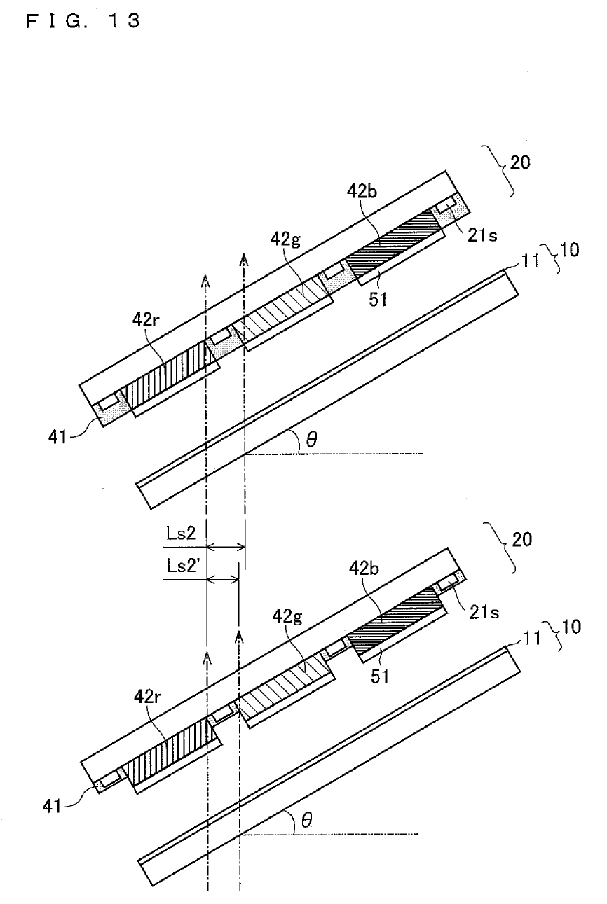

In order to prevent the aperture rate deterioration as described above, it is preferable to arrange at least a film thickness of the black matrix 41 in the vicinity of the end portion thinner than that of the color filter 42, as shown in FIG. 13, instead of arranging the film thickness of the black matrix 41 equal to that of the color filter 42 as in an ordinarily case. This allows the width of the non-aperture region in the vicinity of the end portion of the liquid crystal display panel to be Ls2′(Ls2′<Ls2).

Differentiating the film thicknesses of the black matrix 41 in the vicinity of the center of the liquid crystal display panel and in the vicinity of the end portion thereof may cause the manufacturing steps to be slightly more complex. Alternatively, the film thickness of the black matrix 41 in the vicinity of the center of the liquid crystal display panel may be set equal to that in the vicinity of the end portion of the liquid crystal display panel. Specifically, it is preferable to set a film thickness d of the black matrix 41 thick enough to maintain light blocking capability while setting the above-described (Ls2−Ls1) closer to O. For example, it is preferable to set the film thickness d of the black matrix 41 to about ½ or less of the film thickness of the color filter 42, for example.

It is also true for the liquid crystal display panel 1′ that the aperture rate deterioration in the end portion of the liquid crystal display panel can be prevented with the thinner film thickness of the black matrix 41.

As described above, the liquid crystal display panel 1 of a preferred embodiment is a liquid crystal display panel capable of displaying an image on a curved display surface, in which the liquid crystal display panel has (i) an active matrix substrate 20 having a plurality of pixel electrodes 51 that are two-dimensionally disposed, (ii) an opposed electrode 10 having a common electrode 11 arranged to generate a potential difference between the common electrode 11 and each of the pixel electrodes 51, (iii) a liquid crystal layer 30 sandwiched between the substrates 10 and 20 and arranged to control a light transmission state in accordance with the potential difference, and (iv) a black matrix 41 arranged to cover and hide a space between the pixel electrodes 51. The black matrix 41 is provided in the liquid crystal layer 30 side on the active matrix substrate 20.

In the above preferred embodiment, the black matrix 41 is provided in the liquid crystal layer 30 side on the active matrix substrate 20 having the pixel electrodes 51. Thus, a gap corresponding to the film thickness of the liquid crystal layer 30 does not exist between each of the pixel electrodes 51 and the black matrix 41. This allows the black matrix 41 to properly cover and hide the space between the pixel electrodes in the arbitrarily direction. As a result, it is possible to prevent the aperture rate deterioration and the light leakage that result from the space between the pixel electrodes 51.

Also, in the liquid crystal display panel 1 according to a preferred embodiment of the present embodiment, the color filter 42 is provided in the liquid crystal layer 30 side on the active matrix substrate 20.

In a preferred embodiment of the present embodiment, both the black matrix 41 and the color filter 42 are provided in the liquid crystal layer 30 side on the active matrix substrate 20 having the pixel electrodes 51. Thus, there is not a direction of the visual axis that passes through the color filter 42 of one pixel and also passes through the pixel electrode 51 of a neighboring pixel of another color (see FIG. 11B). Thus, it is possible to avoid the color mixture.

Preferred embodiments of the present invention can be suitably used in providing a curved surface display that is used in an instrumental panel and the like for use in a vehicle.

While preferred embodiments of the present invention have been described above, it is to be understood that variations and modifications will be apparent to those skilled in the art without departing the scope and spirit of the present invention. The scope of the present invention, therefore, is to be determined solely by the following claims.

1-7. (canceled)

8. A liquid crystal display panel with a curved display surface, comprising:
a first substrate having a plurality of pixel electrodes that are arranged in a two-dimensional matrix;
a second substrate having a common electrode arranged to generate a potential difference between the common electrode and each of the pixel electrodes;
a liquid crystal layer sandwiched between the substrates and arranged to control a light transmission state in accordance with the potential difference; and
a black matrix arranged to cover and to hide a space between the pixel electrodes; wherein
the black matrix is arranged on a surface of the first substrate that opposes the liquid crystal layer.

9. The liquid crystal display panel as set forth in claim 8, further comprising:
a color filter arranged to color light that passes through the liquid crystal layer; wherein
the color filter is provided on the surface of the first substrate that opposes the liquid crystal layer.

10. The liquid crystal display panel as set forth in claim 9, wherein the black matrix has a film thickness that is thinner than that of the color filter.

11. The liquid crystal display panel as set forth in claim 9, wherein the black matrix and the color filter are provided between the first substrate and each of the pixel electrodes.

12. The liquid crystal display panel as set forth in claim 8, further comprising:
a color filter arranged to color light that passes through the liquid crystal layer; wherein
the color filter is provided on the surface of the second substrate that opposes the liquid crystal layer.

13. The liquid crystal display panel as set forth in claim 8, wherein each of the first substrate and the second substrate is flexible.

14. A liquid crystal display panel as set forth in claim 13, further comprising a fixing frame arranged to maintain each of the first substrate and the second substrate in a curved condition.
